(19) United States
(12) Patent Application Publication
(10) Pub. No.: US 2006/0246283 A1
(43) Pub. Date: Nov. 2, 2006

(54) Cable insulation compositions with enhanced rheology and processability

(76) Inventors: Geoffrey D. Brown, Bridgewater, NJ (US); Lisa S. Madenjian, Lake Jackson, TX (US); Scott H. Wasserman, Morganville, NJ (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/567,527

(22) PCT Filed: Aug. 11, 2004
(86) PCT No.: PCT/US04/25924

§ 371 Date: Feb. 7, 2006

(30) Foreign Application Priority Data
Aug. 18, 2003 (US) 60495935

(51) Int. Cl. B32B 19/00

(52) U.S. Cl. 428/357

(57) ABSTRACT

The present invention is a telecommunications cable comprising a plurality of electrical conductors, each conductor being surrounded by a layer of insulation comprising a coupled propylene polymer. It is preferable that the propylene polymer be an impact modified propylene polymer, more preferably an impact propylene polymer. The primary advantages of the insulation composition are realized under high-speed extrusion conditions for thin-walled insulation application, including the advantages of smooth insulation surface, good dimensional uniformity, and relatively low extrusion head and die pressures.

This invention relates to telecommunication cables. Specifically, the invention relates to the thin wall insulation layer applied over wires used as electronic signal transmission medium in telecommunication cables.

Twisted pairs of polymer-insulated wires are used as electronic signal transmission medium in telecommunication cables. The insulated wires typically have a thin layer of insulation (that is, thin walled insulation) over fine gauge metal conductors, which conductors generally range from 19 American Wire Gauge (“AWG”) (nominal 0.91 mm diameter) to 26 AWG (nominal 0.40 mm diameter).

The insulated wires are typically fabricated at high production line speeds ranging from 500 to 3000 meters/minute, using a single-screw plasticating extruder. The single-screw plasticating extruder melts, mixes, and pumps the melted polymeric composition through a wire coating crosshead, which in turn applies the polymeric composition to a wire that moves perpendicular to the extruder axis. The polymer-coated wire then passes through a coating die to yield a thin, uniform polymeric insulation layer over the conductor. The insulated wire is then quenched in a water-cooling trough and collected on spools for subsequent fabrication into twisted pair cable. The insulation thickness typically ranges from 0.15 mm to 0.30 mm.

Impact modified propylene polymers, which incorporate medium or high levels of elastomeric modification, are preferred for insulation applications because they provide adequate impact toughness for twisted pair applications. Also, as compared to other insulating compounds, impact modified propylene polymers provide improved deformation resistance, a higher melting point, lower dielectric constants, and lower densities. However, impact modified propylene polymers often exhibit poor surface smoothness after fabrication in the high-speed thin wall insulation extrusion process.

It is therefore desirable to prepare a thin wall insulated wire using an impact modified propylene polymer that has a melt rheology suitable for providing a smooth insulation surface, good dimensional uniformity, and relatively low extrusion head and die pressures at high-speed extrusion conditions. The lower extrusion pressures will also advantageously reduce the tension required to pull the fine gauge wire through the wire-coating crosshead, thereby minimizing undesired stretching and dimensional changes to the wire. It is further desirable that the impact modified propylene polymer compositions achieve good insulation surface smoothness and relatively low extrusion head and die pressures at high-speed extrusion conditions when the composition incorporates flame retardant additives and/or colorants. Flame retardant additives are useful for indoor cable applications while colorants are useful for color coding twisted pairs, thereby facilitating subsequent interconnections.

It is further desirable that the propylene polymer be useful for insulating high-frequency telecommunication wires (that is, data-grade transmission applications) by having a dielectric constant (DC) less than 2.40 and a dissipation factor (DF) less than 0.003. It is even further desirable that the propylene polymer be compatible with hydrocarbon greases, which often fill the space between the insulated twisted pairs in outdoor telecommunication cables to exclude the ingress of water. (The water can deteriorate signal transmission performance and increase the potential for conductor corrosion failures.)

Moreover, it is desirable that the resulting insulation layer have good melt strength, cold bend performance, cut-through and abrasion resistance, and long-term thermo-oxidative aging characteristics. The enhanced melt strength should facilitate better dispersive mixing of fillers during processes such as melt compounding. It is even desired that the impact modified propylene polymer achieve the targeted impact performance while reducing its loading of the elastomeric component, thereby providing for higher initial modulus, enhanced hydrocarbon grease compatibility, and improved deformance resistance.

The invented cable comprises a plurality of electrical conductors, each conductor being surrounded by a layer of insulation comprising a coupled propylene polymer.

As used herein, the following terms shall have the following meanings:

“Coupling agent” means a chemical compound that contains at least two reactive groups that are each capable of forming a carbene or nitrene group that are capable of inserting into the carbon hydrogen bonds of CH, CH2, or CH3 groups, both aliphatic and aromatic, of a polymer chain. The reactive groups can thereby couple separate polymer chains to yield a long chain branching structure. It may be necessary to activate the coupling agent with a chemical coagent or catalyst, or with heat, sonic energy, radiation or other chemical activating energy. Examples of coupling agents include diazo alkanes, geminally-substituted methylene groups, metallocarbenes, phosphazene azides, sulfonyl azides, formyl azides, and azides.

“Extruders” include devices that (1) extrude pellets, (2) coat wires or cables, (3) form films, profiles, or sheets, or (4) blow mold articles.

“Impact modified” propylene polymers incorporate an elastomeric component by reaction or in situ blending or by a compounding process. An example of suitable elastomeric materials for blending or compounding is ethylene-propylene rubber (EPR).

“Impact propylene copolymers” refer to heterophasic propylene copolymers where polypropylene or random copolymer polypropylenes are the continuous phase and an elastomeric phase is dispersed therein. The elastomeric phase may also contain crystalline regions, which are considered part of the elastomeric phase. The impact propylene copolymers are prepared by reactively incorporating the elastomeric phase into the continuous phase, such that they are a subset of impact modified propylene polymers. When an in-reactor process is used, the impact propylene copolymers are formed in a dual or multi-stage process, which optionally involves a single reactor with at least two process stages taking place therein or multiple reactors. See E. P. Moore, Jr in Polypropylene Handbook, Hanser Publishers, 1996, page 220-221 and U.S. Pat. Nos. 3,893,989 and 4,113,802. The impact propylene copolymers preferably have at least 8 weight percent of the elastomeric component based on the total weight of the impact propylene copolymer, more preferably at least 12 weight percent, and most preferably at least 16 weight percent.

When the continuous phase of the impact propylene copolymer is a homopolymer and the elastomeric phase is an ethylene copolymer or terpolymer, the —CH2CH2-units derived from ethylene monomer are present in the impact propylene copolymer in an amount between 5 weight percent and 30 weight percent based on the total weight of the propylene phase. More preferably, the —CH2CH2-units are present in an amount between 7 weight percent and 25 weight percent. Most preferably, the —CH2CH2-units are present in an amount between 9 weight percent and 20 weight percent.

Optionally, the impact propylene copolymers may contain impact modifiers to further enhance the impact properties.

“Impact properties” refer to properties such as impact strength, which are measured by any means within the skill in the art. Examples of impact properties include Izod impact energy as measured in accordance with ASTM D 256, MTS Peak Impact Energy (dart impact) as measured in accordance with ASTM D 3763-93, and MTS total Impact Energy as measured in accordance with ASTM D-3763.

“Rheological properties” refer to the melt-state properties such as the elastic and viscous moduli, the relaxation spectrum or distribution of relaxation times, and the melt strength or melt tension which are measured by any means within the skill in the art.

As previously-noted, the invented cable comprises a plurality of electrical conductors, each conductor being surrounded by a layer of insulation comprising a coupled propylene polymer, having long chain branches incorporated into branching sites of the propylene polymer structure. Preferably, the propylene polymer is an impact modified propylene polymer. More preferably, the propylene polymer is an impact propylene copolymer.

Preferably, the coupled propylene polymer has long chain branches incorporated into branching sites of the propylene polymer structure. Further, Theological improvements may be achieved by also vis-cracking the propylene polymer, before or after coupling.

Specifically, long chain branches can be coupled to the propylene polymer by a post-reactor process, thereby modifying a conventional propylene polymer feedstock. Alternatively, the coupling might be imparted during production of the propylene polymer feedstock via specialized catalyst, co-reactive agents, dual-reactor and post-reactor blending processes and other production technologies. The process is preferably carried out in a single vessel such as a melt mixer or a polymer extruder, such as described in U.S. patent application Ser. No. 09/133,576 filed Aug. 13, 1998.

The propylene polymers useful in the present invention may be made by a variety of catalyst systems, including Ziegler-Natta catalyst, constrained geometry catalyst, and metallocene catalyst.

The uncoupled propylene polymer should have an initial flow rate suitable to yield the desired flow rate after coupling. For conventional impact modified polypropylene in thin wall insulating use, a melt flow rate of 2.5 to 3.5 has typically been preferred for the best balance of properties and high-speed fabricating characteristics. This melt flow range also appears to be optimal for the coupled propylene polymers of the current invention; therefore, the uncoupled propylene polymer should have an initial flow rate suitable to yield a melt flow rate of 2.5 to 3.5 for the resulting coupled propylene polymer.

When compared to the uncoupled propylene polymer, the coupled propylene polymer preferably has a melt flow rate at least 10% less than the melt flow rate of the corresponding uncoupled propylene polymer.

Examples of useful coupling agents include diazo alkanes, geminally-substituted methylene groups, metallocarbenes, phosphazene azides, sulfonyl azides, formyl azides, and azides. Preferred coupling agents are poly(sulfonyl azides), including compounds such as 1, 5-pentane bis(sulfonyl azide), 1,8-octane bis(sulfonyl azide), 1,10-decane bis(sulfonyl azide), 1,10-octadecane bis(sulfonyl azide), 1-octyl-2,4,6-benzene tris(sulfonyl azide), 4,4′-diphenyl ether bis(sulfonyl azide), 1,6-bis(4′-sulfonazidophenyl)hexane, 2,7-naphthalene bis(sulfonyl azide), mixed sulfonyl azides of chlorinated aliphatic hydrocarbons containing an average of from 1 to 8 chlorine atoms and from 2 to 5 sulfonyl azide groups per molecule, oxy-bis(4-sulfonylazidobenzene), 2,7-naphthalene bis(sulfonyl azido), 4,4′-bis(sulfonyl azido)biphenyl, 4,4′-diphenyl ether bis(sulfonyl azide) and bis(4-sulfonyl azidophenyl)methane, and mixtures thereof. See WO 99/10424. If the polymeric composition will contain an antioxidant or other additive package, it may be necessary to adjust the amount of coupling agent to overcome any interference with coupling caused by the antioxidant or additive package.

A relatively low degree of coupling is sufficient to enhance the high-speed extrusion performance. When a bis(sulfonyl azide) is used for the coupling agent, preferably at least 25 parts per million (ppm) of azide is used for coupling the impact propylene copolymer, based on the total weight of the impact propylene copolymer and more preferably at least 50 ppm of azide is used.

Vis-cracking can be used in combination with coupling modification to 30 achieve further rheological improvements. Vis-cracking (also known as controlled rheology) utilizes a peroxide modifier to provide a predominantly chain scission modification of the polymeric structure. The steps of vis-cracking and coupling may be performed sequentially or simultaneously.

The relaxation spectrum index (RSI) can be used to quantify the effect of coupling on the long-relaxation time behavior of a polymer. The RSI represents the breadth of the relaxation time distribution, or relaxation spectrum.

Based on the response of the polymer and the mechanics and geometry of the rheometer used, the relaxation modulus G(t) or the dynamic moduli G′(co) and G″(a) can be determined as functions of time t or frequency ω, respectively. See Dealy et al., Melt Rheology and Its Role in Plastics Processing, Van Nostrand Reinhold, 1990, pages 269 to 297. The mathematical connection between the dynamic and storage moduli is a Fourier transform integral relation, but one set of data can also be calculated from the other using the relaxation spectrum. See Wasserman, J. Rheology, Vol. 39, 1995, pages 601 to 625.

Using a classical mechanical model, a discrete relaxation spectrum consisting of a series of relaxations or “modes”, each with a characteristic intensity or “weight” and relaxation time, can be defined. Using such a spectrum, the moduli are re-expressed as:

$${G}^{′} ( ω ) = {\sum }_{i = 1}^{N} {g}_{i} \frac{{( ω {λ}_{i} )}^{2}}{1 + {( ω {λ}_{i} )}^{2}}$$

$${G}^{′′} ( ω ) = {\sum }_{i = 1}^{N} {g}_{i} \frac{ω {λ}_{i}}{1 + {( ω {λ}_{i} )}^{2}}$$

$$G ( t ) = {\sum }_{i = 1}^{N} {g}_{i} exp ( - t / {λ}_{i} )$$

where N is the number of modes and gi and λi are the weight and time for each of the modes. See Ferry, Viscoelastic Properties of Polymers, John Wiley & Sons, 1980, pages 224 to 263. A relaxation spectrum may be defined for the polymer using software such as IRIS™ Theological software, which is commercially available from IRIS™ Development.

Once the distribution of modes in the relaxation spectrum is calculated, the first and second moments of the distribution, which are analogous to Mn and Mw, the first and second moments of the molecular weight distribution, are calculated as follows:

$${g}_{I} = {\sum }_{i = 1}^{N} {g}_{i} / {\sum }_{i = 1}^{N} {g}_{i} / {λ}_{i}$$

$${g}_{II} = {\sum }_{i = 1}^{N} {g}_{i} {λ}_{i} / {\sum }_{i = 1}^{N} {g}_{i}$$

RSI is defined as gII/gI.

Further, nRSI is calculated from RSI as described in U.S. Pat. No. 5,998,558, according to
nRSI=RSI*MFRˆa
where MFR is the polypropylene melt flow rate as measured using the ASTM D-1238 procedure and a is 0.5. The nRSI is effectively the RSI normalized to an MFR of 1.0, which allows comparison of Theological data for polymeric materials of varying MFRs. RSI and nRSI are sensitive to such parameters as a polymer's molecular weight distribution, molecular weight, and features such as long-chain branching and crosslinking. Accordingly, the RSI and nRSI are useful in determining long-chain branching, which is difficult to measure directly.

Moreover, nRSI is useful in evaluating the relaxation time distribution between polymers because a higher value of nRSI indicates a broader relaxation time distribution. The coupled propylene polymers of the current invention feature a broader distribution of relaxation times, or relaxation spectrum, as quantified by a higher RSI, as compared to the conventional propylene polymers used in their preparation. Preferably, the coupled propylene polymer will have an RSI at least 1.1 times (that is, at least 10% greater than) that of the uncoupled propylene polymer. More preferably, the RSI will at least 1.2 times.

The coupling modification used to provide the coupled propylene polymers of the current invention can be characterized by the following formula:
Y≧1.10
wherein Y is the ratio of the melt strength of the coupled propylene polymer compared to the melt strength of the corresponding propylene polymer prior to coupling. Preferably, Y is 1.20. More preferably, Y is 1.50 with the uncoupled propylene polymer having a melt strength of 2 centiNewtons and the coupled propylene polymer showing a melt strength of 3 centiNewtons. Also, preferably, the melt strength of the coupled propylene polymer is less than 8 centiNewtons.

Generally, the insulation layer is considered a uniform, solid polymeric structure. However, the insulation layer of the present invention can alternatively be a foamed structure, thereby be present as a cellular structure having gas-filled voids. Moreover, the insulation layer can be multilayer structure such as a foam/skin structure wherein the insulation is comprised of an inner layer of foam and a thin outer skin layer. The outer skin layer can be used to provide increased toughness or to incorporate color additives.

When the polymeric composition for preparing the insulation layer is foamed, the insulation layer is characterizes as having a lighter weight and reduced effective dielectric constant and dissipation factor according to the following equations:

$$∈ foam = \frac{P + \sqrt{{P}^{2} + 8 ∈}}{4}$$

$$and$$

$${DF}_{foam} = {DF}_{solid} * ( 1 - E )$$

$$where$$

$$P = ( 2 ∈ - 1 ) - 3 E ( ∈ - 1 )$$

ε is the unfoamed dielectric constant and
E is the expansion (foaming) level.
The reduced dielectric constant reduces the required insulation thickness to achieve the targeted value of coaxial capacitance (insulated wire) and mutual capacitance (finished cable). The polymeric composition for preparing the insulation layer can be foamed by chemical blowing agents or physical foaming.

However, decreased insulation deformation resistance limits the use of foamed insulation for data grade applications. Polymer selection, foaming level, and foam quality are significant factors in optimizing the insulation deformation resistance.

The coupled propylene polymer, the coupled impact modified propylene polymer, or the coupled impact propylene copolymer can be blended with other propylene polymers, including homopolymer propylene polymers, random propylene copolymers and other impact propylene polymers or with other polyolefins to made thermoplastic olefins (TPO's) or thermoplastic elastomers (TPE's). Optionally the other propylene polymers or polyolefins may be coupled with coupling agents.

The polymeric composition for preparing the insulation layer can also contain fillers. Notably, fillers, such as talc, calcium carbonate, or wollastonite, can be used. Also, nucleating agents may be preferably utilized. An example of a nucleating agent is NA-11, which is available from ASAHI DENKA Corporation.

In an alternate embodiment, the present invention is a telecommunications cable comprising a plurality of electrical conductors, each conductor being surrounded by a multilayer insulation structure comprising at least one layer of solid insulation and at least one layer of foamed insulation, wherein at least one of the solid or foamed insulation layers comprises a coupled propylene polymer.

In a preferred embodiment, the present invention is a telecommunications cable comprising a plurality of electrical conductors, each conductor being surrounded by a layer of insulation comprising a coupled propylene polymer, having (a) long chain branches incorporated into branching sites of the propylene polymer structure, (b) a melt strength at least 10% greater than the melt strength of the corresponding uncoupled propylene polymer, (c) a normalized relaxation spectrum index (nRSI) at least 10% greater than the NRSI of the corresponding uncoupled impact propylene copolymer, and (d) a melt flow rate (MFR) at least 10% less than the MFR of the corresponding uncoupled impact propylene copolymer.

The following non-limiting examples illustrate the invention.

Preparation of the Comparative Examples 1 and 3 and Examples 2. 4. and 5

Two impact propylene copolymers available from The Dow Chemical Company were used as the base resins for the examples.

The first base resin was DC 783.00 impact propylene copolymer, having a melt flow rate of 3.8 gram/10 minutes and a 12% ethylene content. The second base resin was C107-04 impact propylene copolymer, having a melt flow rate of 4.0 g/10 min and an ethylene content of 9 weight percent.

Examples 2, 4, and 5 were prepared with the coupling agent, 4,4′-oxy-bis-(sulfonylazido) benzene. When the base resin was DC 783.00 (that is, Example 2), the coupling agent was added in an amount of 140 ppm. When the base resin was C107-04 (that is, Examples 4 and 5), the coupling agent was added in an amount of 200 ppm.

TABLE 1

| | Comp. | | Comp. | | |
|---|---|---|---|---|---|
| Component | Ex. 1 | Ex. 2 | Ex. 3 | Ex. 4 | Ex. 5 |
| DC 783.00 | Yes | Yes | | | |
| C107-04 | | | Yes | Yes | Yes |
| Coupling Agent | | Yes | | Yes | Yes |

To prepare Examples 2, 4, and 5, the base resin was metered directly after polymerization into a ZSK twin screw extruder for the coupling reaction and subsequent pelletizing. An additive feeder was used to meter the desired amount of the coupling agent. Examples 2 and 4 used an antioxidant package suitable for satisfying Telcordia thermo-oxidative aging requirements for grease-filled telephone cable. While Example 5 did not include the antioxidant package needed to satisfy Telcordia thermo-oxidative aging requirements, it contained another antioxidant package.

The selection of the antioxidant packages is incidental to this invention and not necessary for achieving the performance described in the Examples. For the purposes of the invention, persons skilled in the art can identify suitable antioxidant packages to satisfy the aging requirements.

The antioxidant system was combined into a dry preblend and metered through separate additive feeders into the resin feedstream at the ZSK pelletizing extruder feedthroat. A nitrogen purge was maintained on the ZSK feed hopper.

The Example 2 material underwent a processing temperature of 240 degrees Celsius. The melt processing provided good mixing and the proper temperature to activate the coupling agent to modify the base resin.

The Examples 4 and 5 materials were produced separately and extruded through an 11-barrel Werner & Pfleiderer ZSK40 twin screw extruder. The feed rate was 250 lbs/hr. The screw speed was 300 rpm. The target barrel temperature profile was 180/190/200/200/210/220/230/240/230/240/240 degrees Celsius (from feed inlet to die). The processing achieved good mixing and reaction of the coupling agent, with a maximum melt processing temperature of 240 degrees Celsius.

### Melt Properties

The melt properties of the Comparative Examples 1 and 3 and Examples 2 and 4 are reported in Table 2.

TABLE 2

| | Comp. | | Comp. | |
|---|---|---|---|---|
| | Ex. 1 | Ex. 2 | Ex. 3 | Ex. 4 |
| MFR | 3.8 | 3.1 | 4.0 | 3.6 |
| RSI | 5.63 | 7.38 | 5.21 | 14.5 |
| nRSI | 11.0 | 13.0 | 10.4 | 27.5 |
| Melt Strength | 1.96 | 3.15 | | |
| (centiNewtons) | | | | |

The data illustrates the modified rheology achieved by incorporating enhanced molecular structure. In particular, there is a significant increase in melt strength, along with a decrease in MFR when compared to the uncoupled propylene polymer base resin. There is a corresponding increase in the normalized relaxation spectrum index (nRSI) versus the uncoupled propylene polymer base resin.

Melt flow rate (MFR) was measured at 230 degrees Celsius with a 2.16 kg weight according to the method of ASTM D1238. Rheological measurements were done via dynamic oscillatory shear (DOS) experiments conducted with the controlled rate Weissenberg Rheogoniometer, commercially available from TA Instruments. Standard DOS experiments were run in parallel plate mode under a nitrogen atmosphere at 200 or 230 degrees Celsius. Sample sizes ranged from approximately 1100 to 1500 microns in thickness and were 4 centimeters in diameter. DOS frequency sweep experiments covered a frequency range of 0.1 to 100 sec-I with a 2 percent strain amplitude. The TA Instruments rheometer control software converted the torque response to dynamic moduli and dynamic viscosity data at each frequency. Discrete relaxation spectra were fit to the dynamic moduli data for each sample using the IRIS™ commercial software package, followed by the calculation of RSI values as described earlier.

Melt strength for all the samples was measured by using a capillary rheometer fitted with a 2.1 mm diameter, 20:1 die with an entrance angle of approximately 45 degrees. After equilibrating the samples at 190 degrees Celsius for 10 minutes, the piston was run at a speed of 1 inch/minute. The standard test temperature was 190 degrees Celsius. The sample was drawn uniaxially to a set of accelerating nips located 100 mm below the die with an acceleration of 2.4 mm/sec². The required tensile force is recorded as a function of the take-up speed of the nip rolls. The maximum tensile force attained during the test is defined as the melt strength. In the case of polymer melt exhibiting draw resonance, the tensile force before the onset of draw resonance was taken as melt strength.

### Thin Wall Insulation Extrusion

The Comparative Examples 1 and 3 and Examples 2 and 5 were subjected to further processing into extruded wire insulation. Specifically, they were used to prepare thin wall insulation at 1200 ft/minute for a 0.036″ finish diameter on 24 AWG copper (0.020″ diameter).

The extrusion evaluation was performed on pilot plant wire insulating line, The materials were extruded on a 2.5″ diameter, 24:1 L/D Davis Standard extruder equipped with a polyethylene type 3:1 compression screw with barrel temperature of 390/420/450/450/450° C. starting at the feed zone. The line was equipped with a Maillefer 4/6 fixed center crosshead at 450° C. containing a 0.036″ finish diameter insulating die. Pilot plant equipment capabilities limited speed to 1200 feet/minute. This condition typically scales up to 6000 to 8000 feet/minute commercial range with no qualitative change in results.

The results of the evaluation are reported in Table 3.

TABLE 3

| | Comp. | | Comp. | |
|---|---|---|---|---|
| | Ex. 1 | Ex. 2 | Ex. 3 | Ex. 5 |
| MFR | 3.8 | 3.1 | 4.0 | 3.1 |
| Surface | Fair; | Good; | Fair; | Good; |
| Smoothness | 5+ Rating | 7 Rating | 5+ Rating | 7 Rating |
| Extruder Head | 2900 | 3100 | 2600 | 3050 |
| Pressure (PSI) | | | | |

What is claimed is:

1. A telecommunications cable comprising a plurality of electrical conductors, each conductor being surrounded by a layer of insulation comprising a coupled propylene polymer.

2. The cable of claim 1 wherein the coupling modification incorporated long chain branches into branching sites of the propylene polymer.

3. The cable of claim 1 wherein the propylene polymer structure was subjected to vis-cracking.

4. The cable of claim 1 wherein the coupled propylene polymer is selected from the group consisting of coupled impact modified propylene polymers and coupled impact propylene copolymers.

5. The cable of claim 1 wherein the coupled propylene polymer further having a melt strength at least 10% greater than the melt strength of the corresponding uncoupled propylene polymer.

6. The cable of claim 1 wherein the coupled propylene polymer further having a normalized relaxation spectrum index (nRSI) at least 10% greater than the NRSI of the corresponding uncoupled propylene polymer.

7. The cable of claim 1 wherein the coupled propylene polymer further having a melt flow rate (MFR) at least 10% less than the MFR of the corresponding uncoupled propylene polymer.

8. The cable of claim 1 wherein interstices are between the insulated conductors and contain hydrocarbon cable filler grease.

9. A telecommunications cable comprising a plurality of electrical conductors, each conductor being surrounded by a multilayer insulation structure comprising at least one layer of solid insulation and at least one layer of foamed insulation, wherein at least one of the solid or foamed insulation layers comprises a coupled propylene polymer.

10. A telecommunications cable comprising a plurality of electrical conductors, each conductor being surrounded by a layer of insulation comprising a coupled propylene polymer, having (a) long chain branches incorporated into branching sites of the propylene polymer structure, (b) a melt strength at least 10% greater than the melt strength of the corresponding uncoupled propylene polymer, (c) a normalized relaxation spectrum index (nRSI) at least 10% greater than the nRSI of the corresponding uncoupled impact propylene copolymer, and (d) a melt flow rate (MFR) at least 10% less than the MFR of the corresponding uncoupled impact propylene copolymer.
